(19) United States
(12) Patent Application Publication
(10) Pub. No.: US 2007/0185845 A1
(43) Pub. Date: Aug. 9, 2007

(54) SYSTEM AND METHOD FOR SEARCHING IN STRUCTURED DOCUMENTS

(75) Inventor: Katsuhiko Nonomura, Minato-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/669,304

(22) Filed: Jan. 31, 2007

(30) Foreign Application Priority Data
Feb. 1, 2006 (JP) 2006-024540

(51) Int. Cl. G06F 17/30

(52) U.S. Cl. 707/3

(57) ABSTRACT

A document managing apparatus includes: a structured document storing unit that stores a partial-character-string; and a first search processing unit that acquires the partial-character-string according to an acquisition request, transmits an acquisition request for a portion of the partial-character-string, and transmits the acquired partial-character-string to a searching apparatus. A searching apparatus includes: a structure information storing unit that stores structure IDs in correspondence with apparatus IDs; a searching unit that acquires one of the structure IDs that satisfies a search request received from a client; a second acquiring unit that acquires one of the apparatus IDs that is in correspondence with the structure ID; a second request transmitting unit that transmits the acquisition request for the partial-character-string to one of the document managing apparatuses identified with the apparatus ID; and a second result transmitting unit that transmits the partial-character-strings that have been connected to one another to the client.

### CROSS-REFERENCE TO RELATED APPLICATIONS

This application is based upon and claims the benefit of priority from the prior Japanese Patent Application No. 2006-24540, filed on Feb. 1, 2006; the entire contents of which are incorporated herein by reference.

### BACKGROUND OF THE INVENTION

1. Field of the Invention

The present invention relates to a system and a method for managing a large volume of structured documents by arranging them so as to be distributed into a group of structured document databases that have a hierarchized logical structure, and for performing a search therein.

2. Description of the Related Art

In recent years, it has become possible to obtain an extremely large amount of information easily because of development in the information technology. On the other hand, a problem has also arisen where some necessary information is hidden in the large amount of data and cannot be utilized efficiently. There is little point in having a large amount of information if we are not able to utilize the information well. Some pieces of information are unified using one format, and many other pieces of information are in a free format, which means that they are not in any particular format.

A technique called Extensible Markup Language (XML) is expected to serve as a core technology that is able to deal with these pieces of information in a uniform manner. XML is a standard document description language that has a flexible extensibility and coordinatability, and also the supports from major vendors are also guaranteed. A structured document such as an XML document has the following characteristics: (1) The structure is hierarchical; (2) Structure elements having the same path may repeatedly appear in a document; (3) A character string in a partial document may be a long piece of data.

On the other hand, as a means for taking out stored data, there are various types of query languages. In the field of Relational Databases (RDBs), there is a query language called the Structured Query Language (SQL). In the field of XML, a query language called XML Query Language (XQuery) has been developed. XQuery is a query language used for treating XML data as if it was a database. With XQuery, it is possible to take out a group of data that matches a criterion related to the value of a structure element or a criterion related to a hierarchical structure. In addition, by using a regular expression of paths, it is also possible to specify a vague criterion related to a hierarchical structure, such as “a ‘comment’ tag positioned somewhere among the descendents of the ‘document’ tag”.

With structured documents, the target from which some data is taken out is not always the entire structured document. Data is often taken out from one part of a structured document. Also, the access patterns may be different depending on the portions of a document. For example, when a structured document is made up of bibliography information and body information, a large number of users access the bibliography information on a read-only basis, whereas only some of the users access the body information to update it.

On the other hand, it is generally known that the response time is extremely slow if many accesses are made to one particular disk during document searches. To cope with this situation, a technique has been proposed with which the query processing is made to be more efficient by dividing and arranging a large volume of structured documents, not only in units of documents but also in units of subtrees within the documents, while imbalance in the access patterns and the access frequency for the structured documents are taken into consideration.

For example, according to a document titled “A Scheme for Partitioning XML documents based on Access Frequency” by Nobuaki NAKAO et al. (DEWS2004 5A-i5; hereinafter “Document 1”), a high-speed search processing is realized by defining a method for partitioning a structured document horizontally and vertically with a query method called XPath and managing the partitioned document using structure information that is indexed and is called a Repository Guide, so that the structured document is partitioned while the access frequency is taken into consideration.

However, according to the method proposed in Document 1, a problem remains where, when the query result data acquired, if pieces of data being the target are stored in a plurality of disks in a distributed manner, the load resulting from the processing to connect the nodes with one another in the connection portion is large.

More specifically, according to the method proposed in Document 1, one or more partial document candidates are acquired, and the nodes in the connection portion are structurally connected to one another so that the result is narrowed down to a partial document that is actually needed. Subsequently, the partitioned partial documents are connected to one another. In a structured document, because structure elements having the same path repeatedly appear in one document, the number of partial documents being superordinate and subordinate to the connection portion may be large. Thus, there is a possibility that the number of combinations using the superordinate elements and the subordinate elements may be huge. In that situation, the load in the connection processing is large.

To cope with this situation, another technique has been proposed by which, in the connection portion of partitioned partial documents, a node ID indicating a link to a subordinate node is stored in a superordinate node. According to this technique, even if pieces of data being the target are stored in a plurality of disks in a distributed manner, it is possible to generate query result data by following the link and directly accessing from the superordinate node to the subordinate node in the connection portion. Thus, there is no need to perform the structure connection processing, and therefore, the problem experienced with the method in Document 1 does not arise.

However, when this method in which the link is followed is used, a problem arises where duplicate data transfers occur, because the partial documents searched in a link destination apparatus are sequentially transferred to a link source apparatus. In particular, the larger the number of partitions and the number of links are, the more duplicate data transfers occur.

For example, let us discuss a situation in which a document is divided (i.e. partitioned) into three nodes, namely a superordinate node, an intermediate node, and a subordinate node, and two links have been set up. In this situation, the search result transferred from the apparatus storing therein the subordinate node is connected to the search result acquired in the apparatus storing therein the intermediate node, and is further transferred to the apparatus storing therein the superordinate node. In other words, data transfers are performed twice on the search result transferred from the apparatus storing therein the subordinate node.

### SUMMARY OF THE INVENTION

According to one aspect of the present invention, a structured document searching system includes a plurality of document managing apparatuses that stores a structured document in a distributed manner; a searching apparatus that is connected to the document managing apparatuses via a network and that is operable to search in the structured document from the document managing apparatuses; and a client apparatus that is connected to the document managing apparatuses and the searching apparatus via a network and that is operable to transmit a search request for the structured document to the searching apparatus, wherein each of the document managing apparatuses includes: a document storing unit that stores a partial-character-string of the structured document corresponding to a predetermined one of structure elements that are used as units of a logical structure of the structured document; a request receiving unit that receives an acquisition request for the partial-character-string from other ones of the document managing apparatuses and the searching apparatus; a first acquiring unit that acquires the partial-character-string from the document storing unit based on the received acquisition request, and judges whether a portion of the acquired partial-character-string is stored in any one of the other document managing apparatuses, based on information that is contained in the acquired partial-character-string and indicates that a portion of the acquired partial-character-string is stored in one of the other document managing apparatuses; a first request transmitting unit that transmits an acquisition request for the portion of the partial-character-string to the one of the other document managing apparatuses that is judged to store the portion of the partial-character-string, when it is judged that the portion of the partial-character-string is stored in the one of the other document managing apparatuses; and a first result transmitting unit that transmits the acquired partial-character-string to the searching apparatus, and the searching apparatus includes: a structure information storing unit that stores structure IDs and apparatus IDs being kept in correspondence with each other, each of the structure IDs uniquely identifying one of the structure elements, and each of the apparatus IDs uniquely identifying one of the document managing apparatuses that stores the partial-character-string corresponding to the structure elements; a search request receiving unit that receives the search request from the client apparatus; a searching unit that acquires from the structure information storing unit one of the structure IDs of one of the structure elements that satisfies the received search request; a second acquiring unit that acquires from the structure information storing unit one of the apparatus IDs of one of the document managing apparatuses that is in correspondence with the acquired structure ID; a second request transmitting unit that transmits the acquisition request to the one of the document managing apparatuses that is identified with the acquired apparatus ID; a partial-character-string receiving unit that receives the partial-character-string from one or more of the document managing apparatuses; and a second result transmitting unit that connects the received partial-character-strings to one another and transmits a document acquired by connecting the partial-character-strings to the client apparatus, when the partial-character-string is received from each of the document managing apparatuses.

According to another aspect of the present invention, a structured document searching method used in a structured document searching system that includes: a plurality of document managing apparatuses that stores a structured document in a distributed manner; a searching apparatus that is connected to the document managing apparatuses via a network and that is operable to search in the structured document from the document managing apparatuses; and a client apparatus that is connected to the document managing apparatuses and the searching apparatus via a network and that is operable to transmit a search request for the structured document to the searching apparatus, the method comprising: receiving the search request from the client apparatus; acquiring one of the structure IDs of one of structure elements that satisfies the received search request, from a structure information storing unit that stores structure IDs each of which uniquely identifies one of the structure elements that are used as elements of a logical structure of the structured document, in correspondence with apparatus IDs each of which uniquely identifies one of the document managing apparatuses that stores the partial-character-string corresponding to one of the structure elements; acquiring one of the apparatus IDs of one of the document managing apparatuses corresponding to the acquired structure ID, from the structure information storing unit; transmitting an acquisition request to the one of the document managing apparatuses that is identified with the acquired apparatus ID; receiving the acquisition request for the partial-character-string from other ones of the document managing apparatuses and the searching apparatus; acquiring the partial-character-string from a document storing unit that stores the partial-character-string of the structured document corresponding to a predetermined one of the structure elements, based on the received acquisition request; judging whether a portion of the acquired partial-character-string is stored in any one of the other document managing apparatuses, based on information that is contained in the acquired partial-character-string and indicates that a portion of the acquired partial-character-string is stored in the one of the other document managing apparatuses; transmitting an acquisition request for the portion of the partial-character-string to the one of the other document managing apparatuses that is judged to store the portion of the partial-character-string, when it is judged that the portion of the partial-character-string is stored in the one of the other document managing apparatuses; transmitting the acquired partial-character-string to the searching apparatus; receiving the partial character sting from one or more of the document managing apparatuses; and connecting a plurality of the partial-character-strings to one another and transmitting a document acquired by connecting the partial-character-strings to the client apparatus, when more than one character string is received.

### BRIEF DESCRIPTION OF THE DRAWINGS

FIG. 1 is a block diagram of a structured document searching system according to an embodiment of the present invention;

FIG. 2 is a drawing for explaining an example of a structured document in an XML format;

FIG. 3 is a drawing for explaining an example of structure information extracted from a structured document;

FIG. 4 is a drawing for explaining an example of data structure of structure information stored in a structure information storing unit;

FIG. 5 is a drawing for explaining an example of data structure of a structured document stored in a structured document storing unit;

FIG. 6 is a drawing for explaining another example of data structure of a structured document stored in the structured document storing unit;

FIG. 7 is a drawing for explaining an example of data structure of a structured document stored in structured document storing units that are respectively included in a plurality of apparatuses;

FIG. 8 is a drawing for explaining an example of data structure of an index stored in an index information storing unit;

FIG. 9 is a drawing for explaining an example of query data;

FIG. 10 is a block diagram of a first search processing unit;

FIG. 11 is a flowchart of an entire procedure in a structured document storing processing according to the present embodiment;

FIG. 12 is a flowchart of an entire procedure in the structured document search processing according to the present embodiment;

FIG. 13 is a drawing for explaining an example of a calculation of label size;

FIG. 14 is a flowchart of an entire procedure in a partial-character-string acquisition processing according to the present embodiment;

FIG. 15 is a drawing for explaining examples of commands transmitted and received to and from apparatuses during a structured document search processing;

FIG. 16 is a drawing for explaining more examples of commands transmitted and received to and from apparatuses during a structured document search processing;

FIG. 17 is a drawing for explaining an example of a search result acquired in searches performed in apparatuses during a structured document search processing;

FIG. 18 is a drawing for explaining another example of a search result acquired in searches performed in apparatuses during a structured document search processing;

FIG. 19 is a drawing for explaining another example of a search result acquired in searches performed in apparatuses during a structured document search processing;

FIG. 20 is a drawing for explaining an example of data transmitted when a search processing is performed according to a conventional method; and

FIG. 21 is a drawing for explaining an example of data transmitted when a search processing is performed.

### DETAILED DESCRIPTION OF THE INVENTION

Exemplary embodiments of a structured document searching system and a structured document searching method according to the present invention will be explained in detail, with reference to the accompanying drawing.

The structured document searching system according to an embodiment of the present invention realizes a high-speed search processing by transferring search results that are partial documents being arranged in a plurality of document managing apparatuses in a distributed manner, from the document managing apparatuses directly to a searching apparatus that has made a search request.

According to the present embodiment, an example will be explained in which a search is performed in a structured document written in XML, using query data that is written in XQuery.

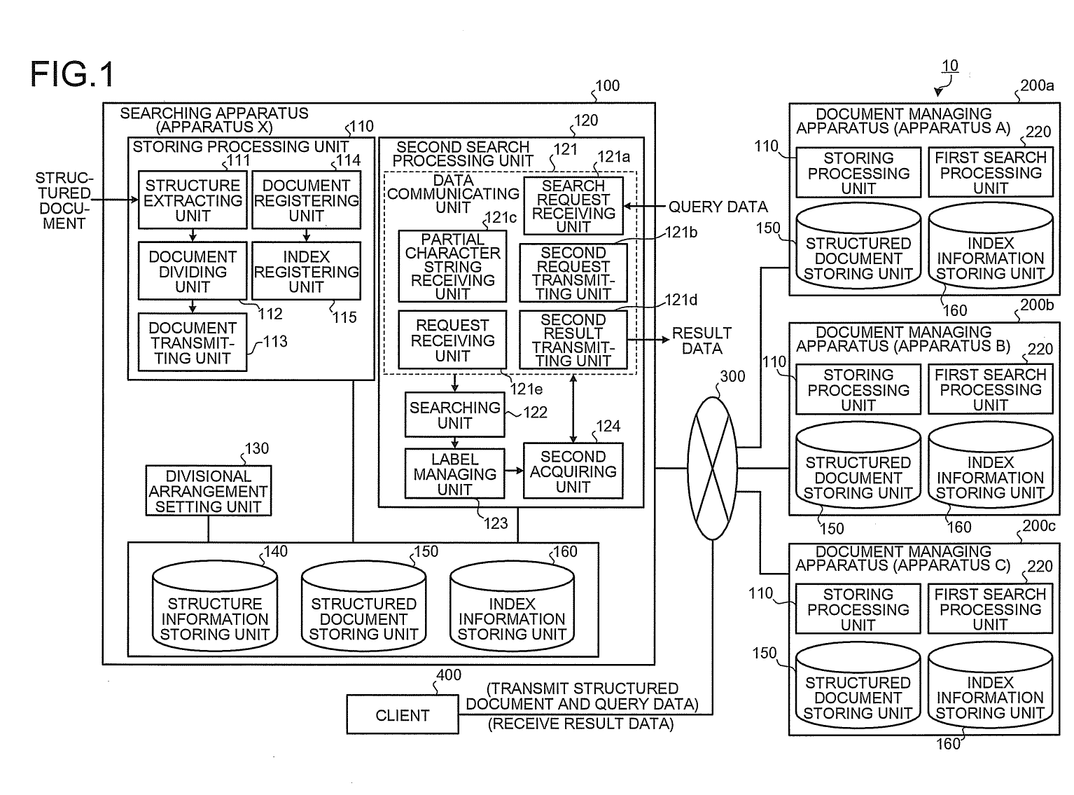

As shown in FIG. 1, the structured document searching system 10 includes a searching apparatus 100, document managing apparatuses 200a, 200b, 200c (hereinafter, the “document managing apparatuses 200”), a network 300, and a client 400.

The client 400 transmits a request for a search in a structured document and is configured with a common Personal Computer (PC) or the like. The client 400 transmits the search request written in XQuery to the searching apparatus 100.

The network 300 is a network that connects the searching apparatus 100, the document managing apparatuses 200, and the client 400 to one another. The network 300 may be configured in any form of network, such as the Internet or a Virtual Private Network (VPN).

The network that connects the client 400 to the searching apparatus 100 may be different from the network that connects the document managing apparatuses 200 to the searching apparatus 100.

The searching apparatus 100 searches in a structured document from the document managing apparatuses 200. According to the present embodiment, the searching apparatus 100 also stores therein a structured document in a distributed manner. Thus, the searching apparatus 100 may search in a structured document from the searching apparatus 100 itself.

In the following description, an example will be explained in which there is one searching apparatus 100, and the searching apparatus 100 performs a search processing of a structured document. However, another arrangement is also acceptable in which there are a plurality of searching apparatuses 100, and each of the searching apparatuses 100 is able to perform a search processing. In the following description, as shown in FIG. 1, the searching apparatus 100 may be called by the apparatus name which is the apparatus X, and the document managing apparatuses 200a, 200b, and 200c may be called by the apparatus names, which are the apparatuses A, B, and C, respectively.

The searching apparatus 100 includes a storing processing unit 110, a second search processing unit 120, a divisional arrangement setting unit 130, a structure information storing unit 140, a structured document storing unit 150, and an index information storing unit 160.

The structure information storing unit 140 stores therein structure information extracted from a structured document in an XML format.

Next, the structured document in an XML format that is dealt with in the present embodiment will be explained.

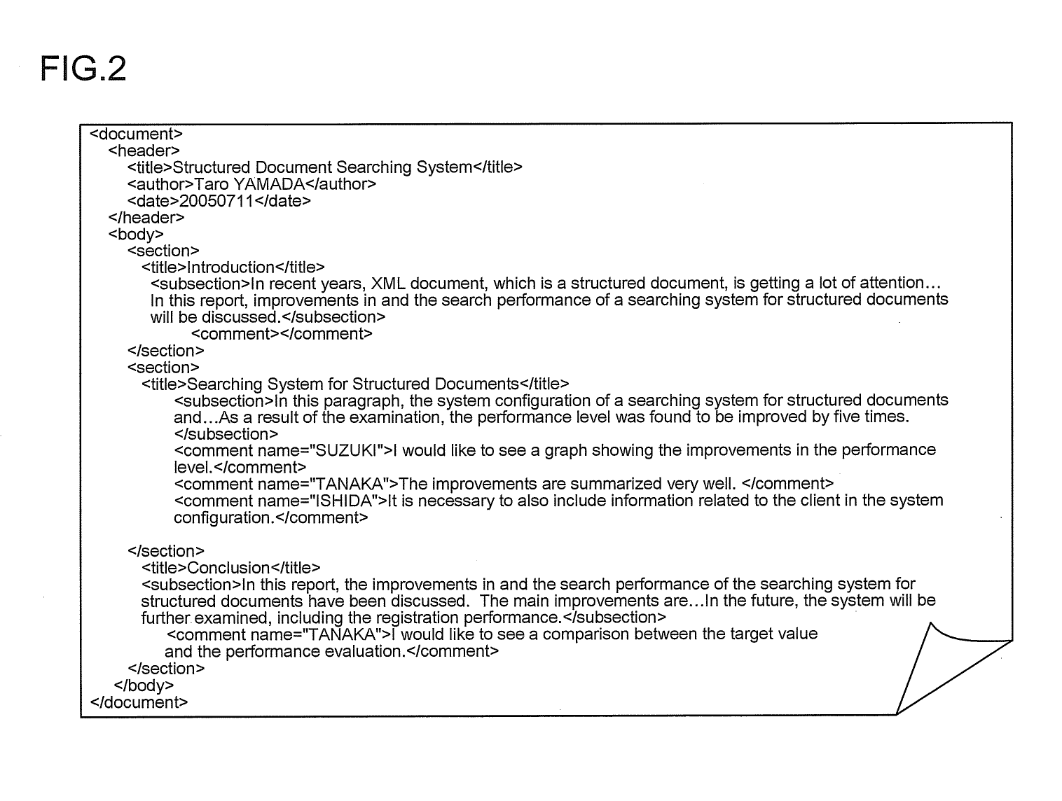

As shown in FIG. 2, the structured document in an XML format is often divided into bibliography information in a <header> tag and body information in a <body> tag. The structured document also includes pieces of information that are stored in one document repeatedly, like the <section> tags and the <comment> tags that are shown in the drawing.

In XML, a unit of data that is defined using a tag is called an “element”. For example, a piece of data that includes a <document> tag and a </document> tag and is enclosed by these tags is one element.

Also, it is possible to specify an attribute with each element, the attribute being used for adding additional information indicating, for example, if the element is omittable or repeatable. In FIG. 2, an example is shown in which a “name” attribute is specified as an attribute of the “comment” element.

In the following description, the contents of the information in an element that is enclosed by a starting tag and an ending tag will be referred to as a “text”. For example, of the “date” element shown in FIG. 2, “20050711” is a text.

The “structure information” includes names of tags, hierarchical relationships, the number of repetitions, and the like that have been extracted from a structured document in an XML format as described above. According to the present embodiment, the element, the attribute, and the text that are described above are the structure elements that denote the elements constituting the structure information of a structured document.

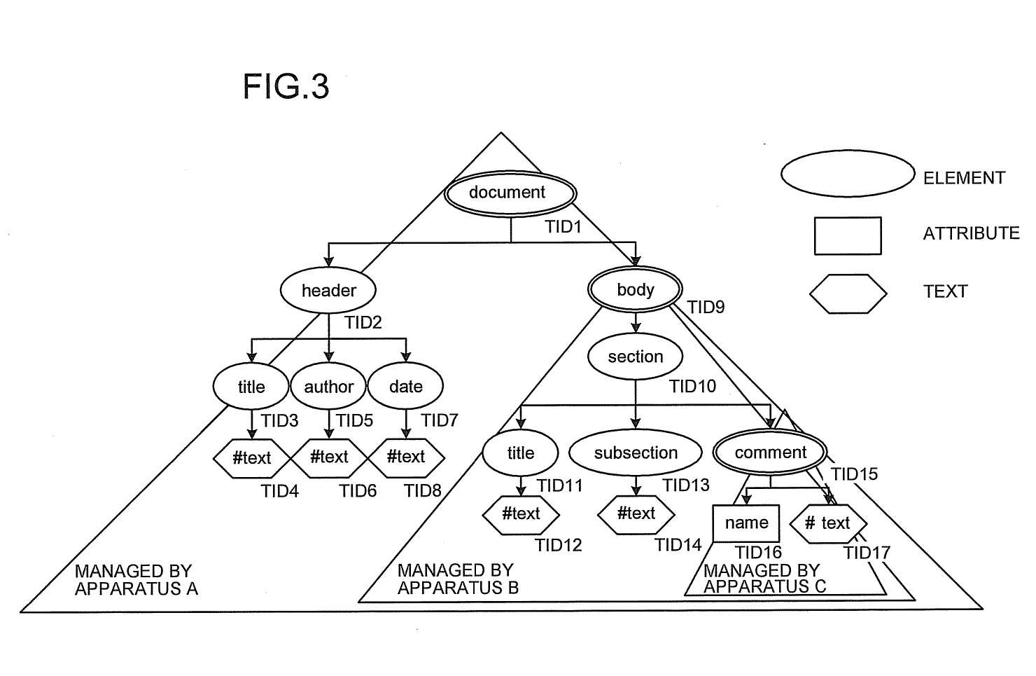

In FIG. 3, the structure information is expressed using a tree structure. The node indicated by an ellipse is a node corresponding to an element (hereinafter, an “element node”). The node indicated by a rectangle is a node corresponding to an attribute (hereinafter, an “attribute node”). The node indicated by a hexagon is a node corresponding to a text (hereinafter, a “text node”).

In the following description, the word “node” is used as a term that expresses each of the nodes in a tree structure in general. Thus, when the structure information is expressed using a tree structure, as shown in FIG. 3, each of the structure elements is a node. On the other hand, when a structured document is expressed using a tree structure, as described later, each partial-character-string, which is a part of a structured document, is a node.

As shown in FIG. 3, a TID, which is an identifier that uniquely identifies a structure element, is assigned to each of the structure elements. In FIG. 3, for example, TID 1 is assigned to a structure element that corresponds to the “document” tag on the “/document” path; TID 2 is assigned to a structure element that corresponds to the “header” tag on the “/document/header” path; TID 3 is assigned to a structure element that corresponds to the “title” tag on the “/document/header/title” path.

Although the structured document includes two “section” tags on the “/document/body/section” path, the structure elements having the same path as each other are condensed to one structure element and, TID 10 is assigned thereto. In addition, for a plurality of structured documents having mutually different structures, generalized structure information that contains all the structured documents is generated by having pieces of structure information overlapping one another.

As additional information, a node that is circled with double lines is a structure element being a division target. In the example shown in FIG. 3, three paths, namely “/document”, “/document/body”, “/document/body/section/comment”, are the structure elements that are division targets. It is indicated that these structure elements that are the division targets are stored in the apparatus A, the apparatus B, and the apparatus C, respectively, in a distributed manner.

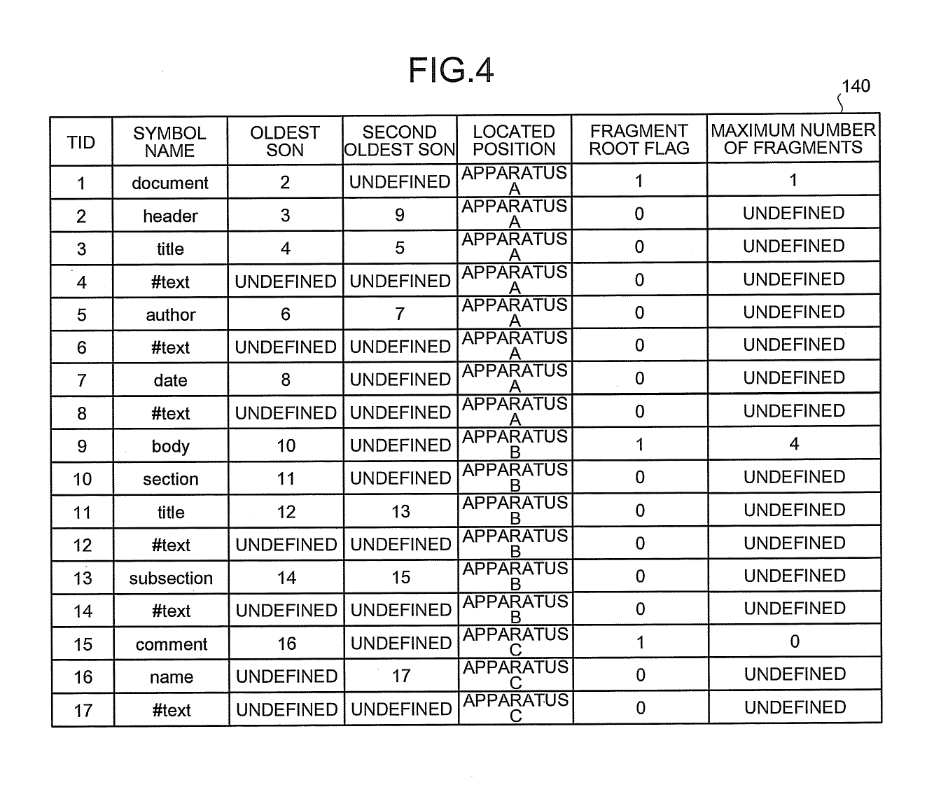

Next, the structure information stored in the structure information storing unit 140 will be explained. The example shown in FIG. 4 shows structure information extracted from the structured document shown in FIG. 2.

In FIG. 4, an example is shown in which, in addition to relationships among the structure elements in the tree structure such as parent-child relationships and sibling relationships in the tree, information related to the divisional arrangements and frequency information in the structured document are stored.

As shown in FIG. 4, the structure information includes the TIDs, the symbol names identifying the names of the structure elements, the TIDs of the structure elements corresponding to the oldest sons, the TIDs of the structure elements corresponding to the second oldest sons, the located positions, the fragment root flags, and the maximum number of fragments, while keeping these pieces of information in correspondence with one another.

In this example, the “fragments” are subtrees that are acquired by dividing a tree so that the subtrees can be arranged in mutually different apparatuses respectively, in a distributed manner. Each “fragment root” is a structure element being a root of a subtree acquired by dividing the tree. Each “fragment root flag” is information indicating whether the structure element is a fragment root. More specifically, when the fragment root flags of some structure elements are each “1”, it means that the structure elements are division targets of a structured document and are to be arranged in mutually different apparatuses in a distributed manner, respectively.

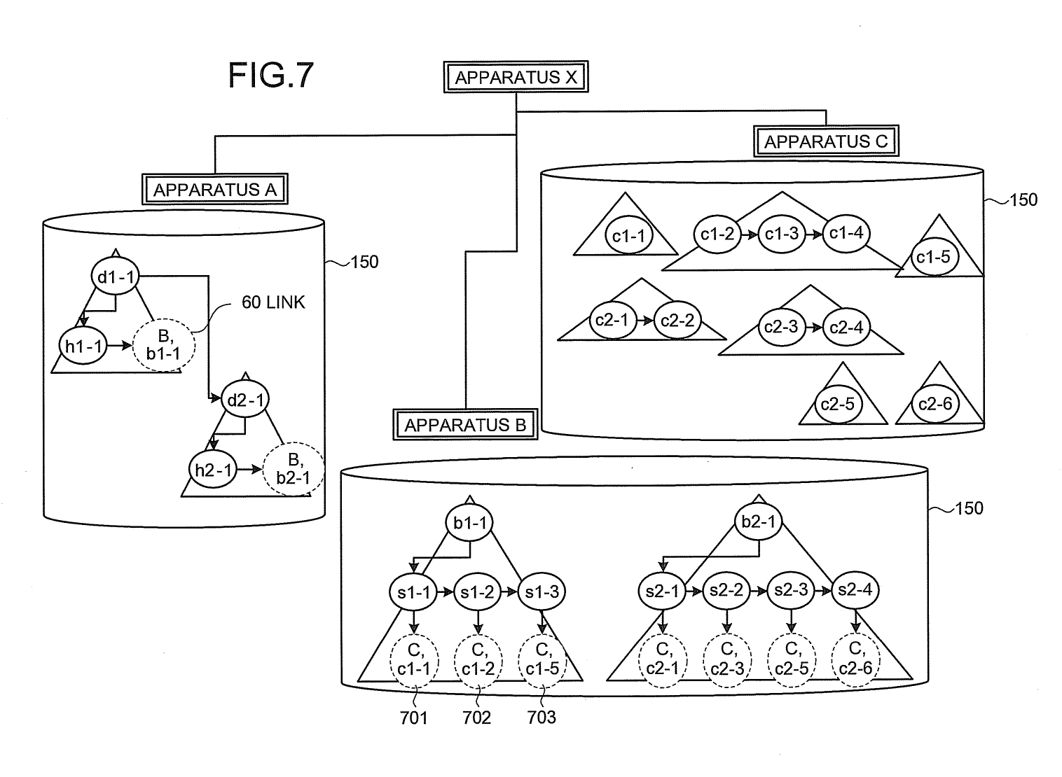

The “maximum number of fragments” is information indicating the maximum number of fragments that are positioned under the fragment. For example, in the structured document shown in FIG. 2, as shown with a “body” element (b1-1) stored in the apparatus B in FIG. 7, there are three comment elements (i.e. the elements 701, 702, and 703). Thus, if the number of “comment” elements within each of the “body” elements in other structured documents stored in the structured document storing unit 150 is equal to or smaller than 3, the maximum number of fragments will be three. In the example shown in FIG. 4, because there is another structured document in which the number of “comment” elements under the “body” element is 4, the maximum number of fragments is 4.

The “maximum number of fragments” is information that indicates the frequency with which divided fragments appear in a structured document. Thus, the information will be called frequency information of the structured document.

In FIG. 4, for example, as for the node identified with TID 1, as the information indicating the parent-child and the sibling relationships in the tree, it is shown that the symbol name is “document”, and the node TID 1 is related with TID 2, which is its oldest son. Also, as the information related to the divisional arrangements, it is shown that the location position is the apparatus A and that the node with TID 1 is a structure element being a division target because “the fragment root flag is 1”. In addition, as the frequency information of the structured document, it is shown that the maximum number of repetitions is 1, and also the number of fragments under the node per structured document is 1.

It is considered that the structure information is updated considerably less frequently than document information or index information. Thus, even if a system in which updates are performed on-line is used, it is possible to store the structure information into a memory in each apparatus so that the structure information is shared while the information is kept consistent.

The structured document storing unit 150 stores therein structured documents in an XML format.

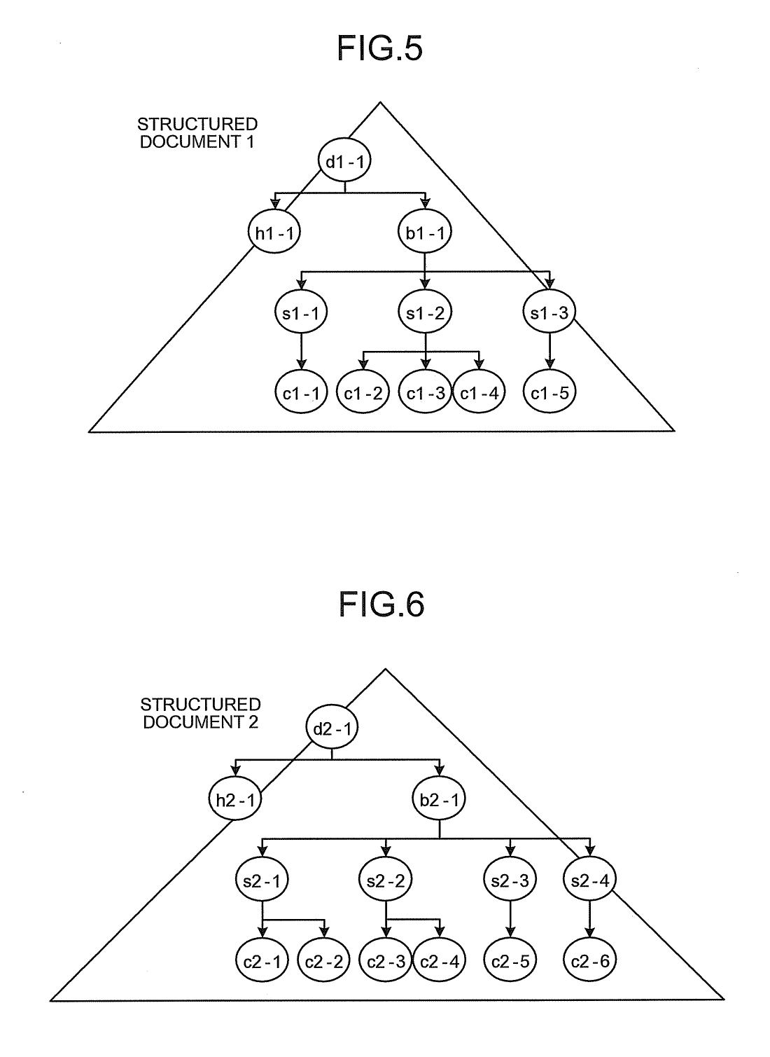

As shown in FIG. 5 and FIG. 6, the structured document storing unit 150 expresses each structured document with a tree structure and stores therein each structured document while an ID that uniquely identifies a node is assigned to each of the nodes in the tree structure.

The structured document 1 shown in FIG. 5 shows a tree structure in which IDs are assigned to the nodes that correspond to a “document” tag, a “header” tag, a “body” tag, a “section” tag, and a “comment” tag, in the structured document shown in FIG. 2. In actuality, contents of other tags in the structured document shown in FIG. 2 are also stored in the structured document 1. For example, under the node identified with the ID=h1-1, a “title” tag, an “author” tag, and a “date” tag are also included.

The structured document 2 shown in FIG. 6 shows a tree structure that corresponds to a structured document that is different from the structured document shown in FIG. 2. The structured document 2 is, for example, a structured document in which there are four “section” tags that are included in the “body” tag.

In FIG. 5 and FIG. 6, examples of data structure are shown in which one structured document is stored in one apparatus. When one structured document is stored in a plurality of apparatuses in a distributed manner, fragments, which are the subtrees acquired by dividing a tree structure shown in FIG. 5 or FIG. 6, are stored into the apparatuses respectively, in a distributed manner.

In FIG. 7, a state is shown in which the structured document 1 and the structured document 2 are arranged in distributed manner into the three apparatuses, namely the apparatus A, the apparatus B, and the apparatus C, according to the setting in the structure information shown in FIG. 4.

In FIG. 4, the setting specifies that the structure elements identified with TID 1 to TID 8 are stored in the apparatus A. Thus, as shown in FIG. 7, the structure elements identified with the node ID “h1-1” (corresponding to a document tag) and the node ID “h1-1” (corresponding to a header tag) from the structured document 1 as well as the structure elements identified with the node ID “d2-1” and the node ID “h2-1” from the structured document 2 are stored in the apparatus A.

Further, as shown in FIG. 4, the second oldest son of the structure element identified with the TID=2 is the structure element identified with the TID=9 (corresponding to a body tag); however, the location position of the structure element identified with the TID=9 is the apparatus B. Thus, a link, which is connection information indicating that the structure element is stored in another apparatus, will be set up. For example, as indicated by a link 60 shown in FIG. 7, instead of the node corresponding to the structure element identified with the TID=9 , a link that brings the apparatus name into correspondence with the node ID is set up with the node identified with the node ID “h1-1”.

With this arrangement, it is possible to maintain the parent-child relationship and the sibling relationship among the structure elements that are arranged in the apparatuses in a distributed manner. More specifically, it is understood that the second oldest son of the node identified with the node ID “h1-1” is stored in the apparatus B and is identified with the node ID “b1-1”.

The method for setting up a link is not limited to the example described above. It is acceptable to specify, instead of the apparatus name, a TID that is managed in the structure information. Because each of the apparatuses is able to refer to the structure information storing unit 140 included in the searching apparatus 100 (i.e. the apparatus X), each apparatus is able to identify the located position that corresponds to the TID of the target node.

The index information storing unit 160 stores therein an index for making a search in structured documents faster.

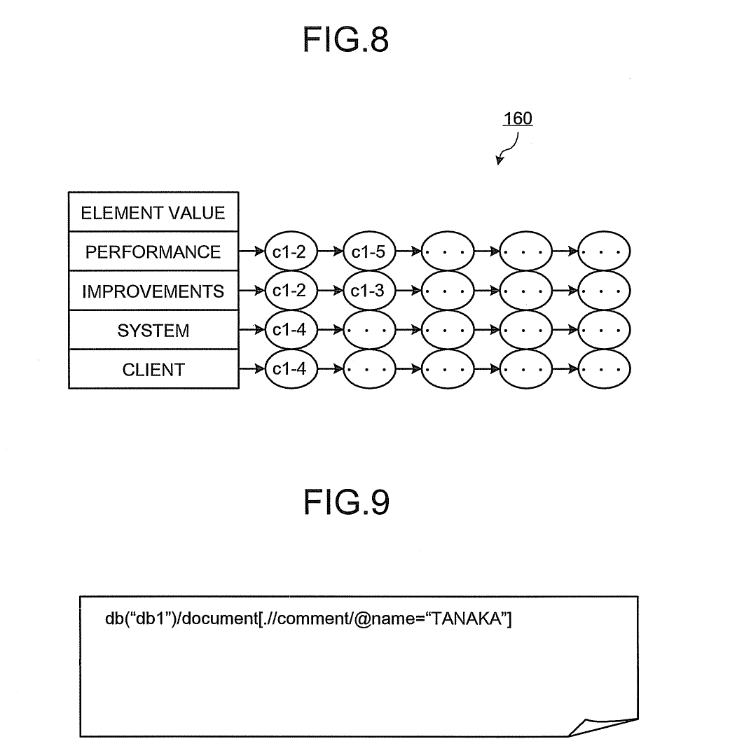

In FIG. 8, an example of an index that makes a search in the text stored in a structured document faster is shown. As shown in the drawing, the index shows the element values, which indicate pieces of information that are stored, in correspondence with the node IDs, which indicate the stored locations.

The data structure of the index is not limited to this example. It is acceptable to apply any type of index that has been conventionally used, as long as the index makes a search in structured documents faster. Alternatively, another arrangement is acceptable in which an index is stored that makes a search in structure elements included in structured documents faster.

Each of the structure information storing unit 140, the structured document storing unit 150, and the index information storing unit 160 may be configured with any storage medium that is generally used, such as a Hard Disk Drive (HDD), an optical disk, a memory card, or a Random Access Memory (RAM).

The storing processing unit 110 performs a storing processing to store structured documents into the structured document storing unit 150. The storing processing unit 110 includes a structure extracting unit 111, a document dividing unit 112, a document transmitting unit 113, a document registering unit 114, and an index registering unit 115.

The storing processing of a structured document can be divided into two phases. In the first phase, the structure information of the document is extracted from a structured document that has been input and is stored into the structure information storing unit 140. Also, the structured document is divided with reference to the structure information. The segments acquired by dividing the structured document are transmitted to the document managing apparatuses 200, respectively. The first phase is performed by the structure extracting unit 111, the document dividing unit 112, and the document transmitting unit 113.

The second phase is, in principle, performed by the storing processing units 110 included in the document managing apparatuses 200. In the second phase, the segments of the structured document are stored into the structured document storing units 150, and also the index information is stored into the index information storing units 160. The second phase is performed by the document registering units 114 and the index registering units 115.

The structure extracting unit 111 extracts, from a structured document, the structure elements that constitute the document. When XML is used, it is possible to apply any method for extracting structure elements that is conventionally used; for example, a method by which an object tree is generated according to a Document Object Model (DOM) may be used.

In addition, when having extracted a new piece of structure information not being included in the structure information that has already been stored in the structure information storing unit 140, the structure extracting unit 111 stores the new piece of structure information into the structure information storing unit 140.

The document dividing unit 112 divides the structured document that has been input, by referring to the structure information stored in the structure information storing unit 140. The details of the structure information will be described later.

The document transmitting unit 113 transmits the segments of the structured document divided by the document dividing unit 112 to the document managing apparatuses 200, according to the located position information included in the structure information stored in the structure information storing unit 140. When the segments of the structured document are stored into the structured document storing unit 150 included in the searching unit 100, the document transmitting unit 113 transmits the segments of the structured document to the document registering unit 114 included in the searching apparatus 100.

The document registering unit 114 stores the structured document transmitted by the document transmitting unit 113 into the structured document storing unit 150.

The index registering unit 115 generates the index that makes a search in the structured document faster and stores the generated index into the index information storing unit 160. As describe above, the data structure of the index may be any structure that has been conventionally used. Thus, it is possible to use any method for generating an index, depending on the index to be applied.

The second search processing unit 120 performs a processing of searching in the structured documents stored in the structured document storing unit 150. The second search processing unit 120 includes a data communicating unit 121, a searching unit 122, a label managing unit 123, and a second acquiring unit 124 for acquiring a second result data.

The data communicating unit 121 transmits and receives data to and from the client 400 or each one of the document managing apparatuses 200, which are external apparatuses. The data communicating unit 121 includes a search request receiving unit 121a, a second request transmitting unit 121b, a partial-character-string receiving unit 121c, a second result transmitting unit 121d, and a request receiving unit 121e.

The search request receiving unit 121a receives query data transmitted from the client 400.

If there is any partial-character-string that is stored in an external apparatus, the second request transmitting unit 121b transmits a command for acquiring the partial-character-string to the external apparatus.

The partial-character-string receiving unit 121c receives partial-character-strings that are transmitted from any of the document managing apparatuses 200, which are the external apparatuses.

The second result transmitting unit 121d transmits result data to the client 400 being a query requesting source, the result data having been generated by a result data generating unit 128, which is described later, by connecting the partial-character-strings received by the partial-character-string receiving unit 121c.

The request receiving unit 121e receives a command that is for acquiring a partial-character-string and has been transmitted from any of the external apparatuses.

The searching unit 122 acquires a set made up of node IDs of the root nodes of the partial-character-strings that match the query data that is in XQuery format and has been received from the client 400.

More specifically, the searching unit 122 performs a syntax analysis on the query data and generates a query graph. Next, the searching unit 122 extracts a structure that is required in the query processing from the query graph and acquires the node IDs of the root nodes of the partial-character-strings that match the query data, by referring to the structured document storing unit 150 and the index information storing unit 160, using the extracted structure.

The query data shown in FIG. 9 indicates a criterion defining that “a list of ‘document's should be acquired, the list containing the structure elements called ‘document’ under which the value of a ‘name’ attribute in a ‘comment’ tag positioned under the structure element ‘document’ is equal to ‘TANAKA’ within a hierarchy tree for the structured document DB ‘db1’.”

With the query data as described above, zero or more node IDs of the structure elements with “document” tags are acquired. Also, with the query data in the format as describe above, it is possible to obtain result data in units of structured documents or in units of partial documents and also to generate a structured document that is in a new format by putting together one or more partial documents.

According to the frequency information related to the partial-character-strings that are the structure element being the acquisition target and the structure elements thereunder, the label managing unit 123 calculates the size of a label used for managing pieces of character string data corresponding to the fragments and generates the label having the calculated size. The method for calculating the label size and the format of the label will be explained later.

The second acquiring unit 124 acquires result data, which is a search result, by using the label generated by the label managing unit 123, with reference to the structure information stored in the structure information storing unit 140. More specifically, when the nodes under the node ID acquired by the searching unit 122 are stored in the structured document storing unit 150 of the searching apparatus itself, the second acquiring unit 124 acquires the corresponding nodes from the structured document storing unit 150, as the result data. Alternatively, when a link to an external apparatus is set up under the node ID acquired by the searching unit 122, the second acquiring unit 124 performs a processing of requesting the external apparatus to obtain the result data.

The divisional arrangement setting unit 130 specifies information related to structure elements that are division targets of a structured document and the positions at which the fragments acquired by the division are arranged, according to an instruction from a user and also updates the structure information stored in the structure information storing unit 140. More specifically, the divisional arrangement setting unit 130 enables the user to specify the located positions and the fragment root flags that are included in the structure information shown in FIG. 4. As a result, the user becomes able to specify how to divide and arrange the structure elements that are acquired by the division.

The document managing apparatuses 200a, 200b, and 200c stores therein a structured document in a distributed manner. Also, each of the document managing apparatuses 200a, 200b, and 200c performs a search processing on the stored structured document in response to a request from the searching apparatus 100.

The document managing apparatuses 200a, 200b, and 200c have the same configuration with one another. In the following description, unless it is not appropriate, the document managing apparatuses 200a, 200b, and 200c will be collectively referred to as the “document managing apparatuses 200”. It is sufficient that the structured document searching system 10 includes at least one document managing apparatus 200. Also, the number of document managing apparatuses 200 included in the system is not limited to three.

Each of the document managing apparatuses 200 includes the storing processing unit 110, a first search processing unit 220, the structured document storing unit 150, and the index information storing unit 160.

As explained here, each of the document managing apparatuses 200 is different from the searching apparatus 100 in that it does not include the divisional arrangement setting unit 130 and the structure information storing unit 140. The reason is because the structure information is used for storing information related to the structure of an entire structured document that is arranged in the document managing apparatuses 200 in a distributed manner and is managed inside the searching apparatus 100 in a unified manner.

Also, each of the document managing apparatuses 200 is different from the searching apparatus 100 in that it includes a first search processing unit 220, instead of the second search processing unit 120.

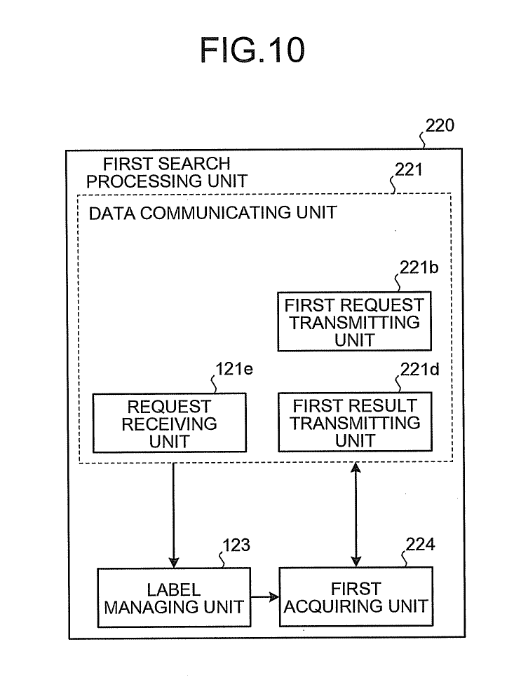

As shown in FIG. 10, the first search processing unit 220 includes a data communicating unit 221, a label managing unit 123, and a first acquiring unit 224 for acquiring a first result data.

The data communicating unit 221 transmits and receives data to and from one of the client 400 and the document managing apparatuses 200 that are the external apparatuses. The data communicating unit 221 includes a first request transmitting unit 221b a first result transmitting unit 221d, and a request receiving unit 121e.

Unlike the second search processing unit 120 included in the searching apparatus 100, the first search processing unit 220 includes neither the search request receiving unit 121a nor the partial-character-string receiving unit 121c. The reason is because these units are used for transmitting and receiving data to and from the client 400. Also, unlike the second search processing unit 120 included in the searching apparatus 100, the first search processing unit 220 does not include the searching unit 122. The reason is because the searching unit 122 functions so as to obtain a node ID of the root node on which a request to each of the document managing apparatuses 200 that a partial-character-string should be acquired is based, by referring to the query data received from the client.

When each of the document managing apparatuses 200 is configured so as to receive query data from the client 400 and to return a search result, it is also acceptable to configure the first search processing unit 220 so as to include the search request receiving unit 121a, the partial-character-string receiving unit 121c, and the searching unit 122.

The functions of the first request transmitting unit 221bthe request receiving unit 121e, the label managing unit 123, and the first acquiring unit 224 are the same as the functions of the second request transmitting unit 121b, the request receiving unit 121e, the label managing unit 123, and the second acquiring unit 124 that are included in the searching apparatus 100. Thus, the explanation thereof will be omitted.

The first result transmitting unit 221d transmits, to an apparatus defined as a return destination, a partial-character-string that has been acquired in response to a command that is received from another apparatus and indicates that the partial-character-string should be acquired. The apparatus being the return destination is specified in the command requesting the acquisition of the partial-character-string. According to the present embodiment, in principle, the searching apparatus 100 is specified as the return destination apparatus.

The configurations and the functions of the storing processing unit 110, the structured document storing unit 150, and the index information storing unit 160 that are included in each of the document managing apparatuses 200, as shown in FIG. 1, are the same as those included in the searching apparatus 100. Thus, the explanation thereof will be omitted.

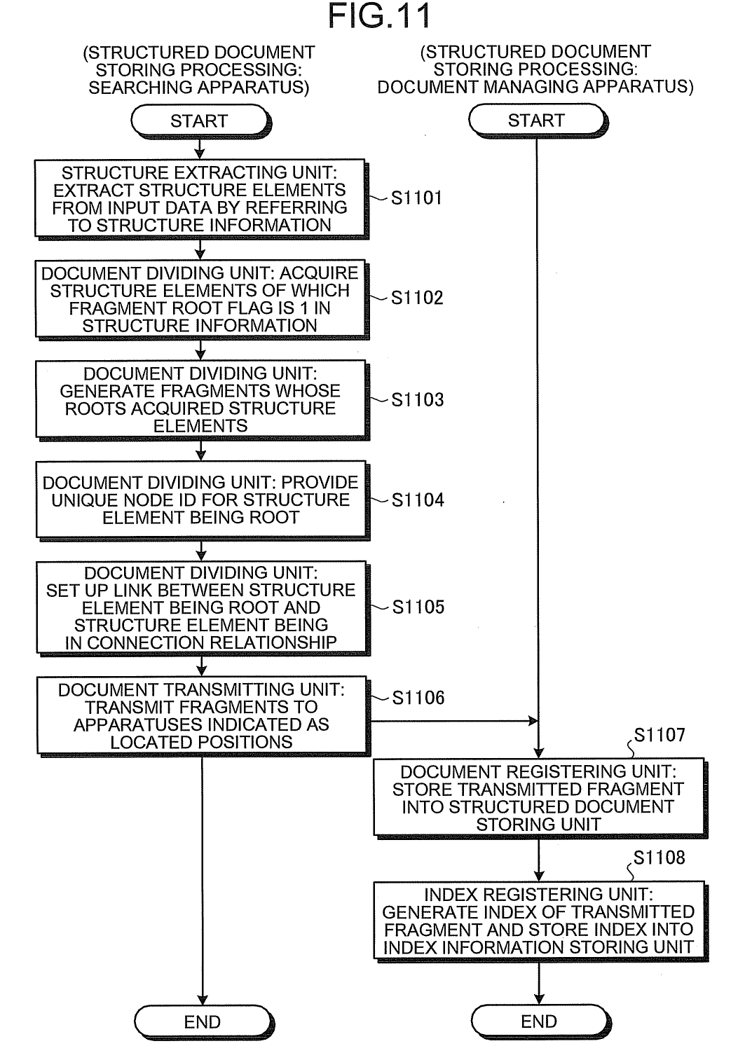

Next, a structured document storing processing performed by the structured document searching system 10 that is configured as described above according to the present embodiment will be explained, with reference to FIG. 11. The structured document storing processing is a processing for storing a structured document in a distributed manner, as a prerequisite for the structured document search processing, which is described later.

First, the structure extracting unit 111 extracts structure elements from input data of a structured document that has been input by the client 400, by referring to the structure information stored in the structure information storing unit 140 (step S1101).

In this situation, if there are one or more new structure elements that are not included in the structure information stored in the structure information storing unit 140, information of the new structure elements are added to the structure information so that the structure information storing unit 140 is updated.

Next, the document dividing unit 112 acquires structure elements of which the fragment root flag is indicated as 1 in the structure information, by referring to the structure information stored in the structure information storing unit 140 (step S1102). For example, when the structured document 1 shown in FIG. 5 is stored, three structure elements having the paths “/document”, “/document/body”, and “/document/body/section/comment/” are acquired out of the structure information shown in FIG. 4.

Next, the document dividing unit 112 generates fragments whose roots are the acquired structure elements (step S1103). Next, the document dividing unit 112 provides a unique node ID for each of the structure elements that are the roots of the fragments (step S1104).

Next, the document dividing unit 112 sets up a link between each structure element being a root and the structure element that is in a connection relationship with the structure element (step S1105). For example, when the structured document 1 as shown in FIG. 5 is stored, a link is set up between the node that is identified with the node ID=b1-1 and is the root node of the fragment stored in the apparatus B and the node that is identified with the node ID=h1-1 and is the structure element stored in the apparatus A. As a result, a link such as the link 60 shown in FIG. 7 has been set up.

Next, the document transmitting unit 113 transmits each of the fragments to the apparatus indicated as the location position in the structure information (step S1106). For example, when the structure information as shown in FIG. 4 is used as an example, the fragment whose root node is identified with the node ID=d1-1 is transmitted to the apparatus A. In a similar manner, the fragment whose root node is identified with the node ID=b1-1 is transmitted to the apparatus B, whereas the fragment whose root node is identified with the node ID=c1-1 is transmitted to the apparatus C.

Subsequently, each of the document managing apparatuses 200 (i.e. the apparatus A, the apparatus B, and the apparatus C) performs the structured document storing processing through a processing as described below.

First, the document registering unit 114 stores the transmitted fragment into the structured document storing unit 150 (step S1107). Next, the index registering unit 115 generates an index of the transmitted fragment and stores the generated index into the index information storing unit 160 (step S1108). Thus, the structured document storing processing is ended.

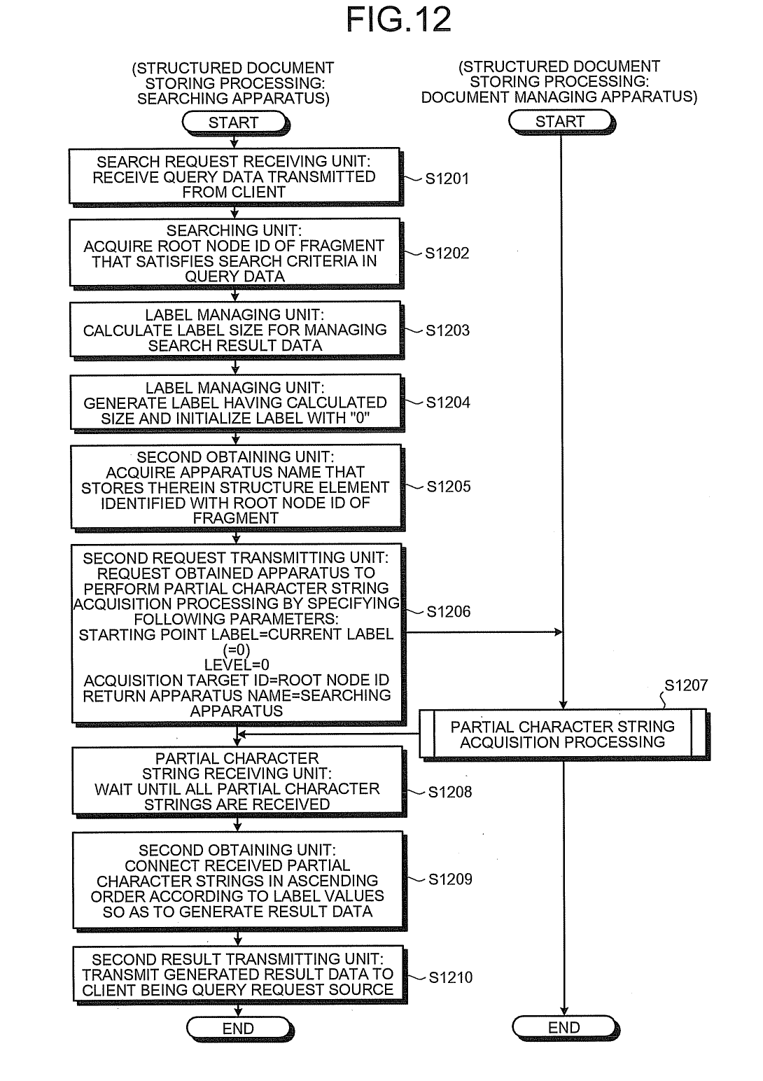

Next, the structured document search processing performed by the structured document searching system 10 that is configured as described above according to the present embodiment will be explained, with reference to FIG. 12.

First, the search request receiving unit 121a receives query data transmitted from the client 400 (step S1201). Next, the searching unit 122 acquires the node ID of the root node (hereinafter, the “root node ID”) of the fragment that satisfies the search criteria indicated in the query data (step S1202).

For example, when query data as shown in FIG. 9 is received, the structured document as shown in FIG. 2 satisfies the criteria. Thus, the root node ID=d1-1 of the structured document 1 shown in FIG. 5 that corresponds to FIG. 2 is acquired.

Subsequently, the label managing unit 123 calculates the size of a label, which is information used for managing the search result data (step S1203). In principle, the label is calculated using Expression (1) shown below:
Label size (bits)=Σ label size of the fragment on level i=Σ log₂(max(the maximum number of fragments of the fragment on level i)+2) (1)

In this expression, the “level” denotes information expressing the depth of the division. More specifically, the level is information that indicates the number of times division is performed, starting from the acquired root node of an entire fragment, until the fragments resulting from the division is acquired.

For example, when the structured document 1 shown in FIG. 5 is acquired, the fragment of which the root node is identified with the node ID=b1-1 is generated by dividing the structured document 1 once. Thus, the level is expressed as “1”. As another example, the fragment of which the root node is identified with the node ID=c1-1 is generated by dividing the structured document 1 twice. Thus, the level is expressed as “2”. The level of the fragment being the entire structured document 1 is “0”.

The symbol “max” means that, when there are a plurality of fragments on the same level as one another, the maximum value of a calculated value should be acquired. With this arrangement, by ensuring that the maximum label size on each level is acquired, it is possible to perform the acquisition processing of a plurality of subtrees that are positioned on the same level, using one label.

The reason why “2” is added is because it is necessary to have a size acquired by adding “1” (i.e. +1) to assign “0” to the starting point. Further, the fragment on the level i is divided by the fragments on level (i+1) of which there are as many as the number of fragments. Thus, it is necessary to have a size acquired by “the number of fragments+1”.

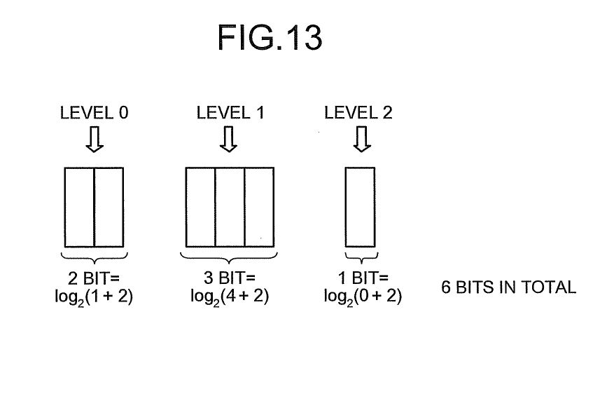

In FIG. 13, an example is shown in which a label size is calculated for managing the search result from the structured document 1 shown in FIG. 5.

The maximum number of fragments for the fragment on level 0, in other words, for the fragment being the entire structured document 1 is “1”, as shown in FIG. 4. Accordingly, the label size of the fragment on level 0 is log₂(1+2)=2. In a similar manner, the label size of the fragment on level 1 is 3, whereas the label size of the fragment on level 2 is 1.

The label is information having bit data that has a size calculated in this manner. The label is further divided in units of the levels. On each level, a value is assigned to each partial-character-string that is acquired through a partial-character-string acquisition processing, which is described later. At this time, a value acquired by adding 1 is assigned in an order based on the tree structure of the structured document. Thus, the searching apparatus 100 receives partial-character-strings from the document managing apparatuses 200 and changes the order in which the partial-character-strings are arranged appropriately by referring to the values in the labels. Thus, the searching apparatus 100 generates a structured document that serves as result data.

After the label size is calculated at step S1203, the label managing unit 123 generates a label having the calculated size and initializes the label with an initial value, which is “0” (step S1204).

Next, the second acquiring unit 124 acquires, out of the structure information storing unit 140, the apparatus name of one of the document managing apparatuses 200 that stores therein the structure element identified with the root node ID of the fragment that satisfies the search criteria, the root node ID having been acquired at step S1202 (step S1205). For example, the symbol name of the node identified with the root node ID=d1-1 is “document”. Thus, the apparatus A is acquired out of the structure information storing unit 140, as the located position.

Next, the second request transmitting unit 121b transmits, to the apparatus that has been determined as the located position, a command requesting that a partial-character-string acquisition processing should be performed and in which parameters are specified (step S1206). The parameters include a starting point label, a level, an acquisition target ID, and a return apparatus name.

The “starting point label” denotes a label that serves as a base to which a value is added in the partial-character-string acquisition processing. In principle, the label on which a processing is currently performed (hereinafter, a “current label”) is the starting point label used in the following partial-character-string acquisition processing.

The “acquisition target ID” denotes a root node ID of a tree structure representing the partial-character-string acquired in the partial-character-string acquisition processing.

The “return apparatus name” is information indicating the apparatus name of the apparatus to which the partial-character-string acquired by the document managing apparatus 200 is returned. In principle, the name of the searching apparatus 100 (i.e. the apparatus X) is specified. However, if the system includes a plurality of searching apparatuses 100, the apparatus name of one of the searching apparatuses 100 that has requested that the partial-character-string acquisition processing should be performed is specified.

For example, when the structured document 1 as shown in FIG. 5 is acquired, the second request transmitting unit 121b transmits, to the apparatus A, a command in which the starting point label=the current label, the level=0, the acquisition target ID=d1-1, and the return apparatus name=the apparatus X are specified.

When the command requesting that a partial-character-string acquisition processing should be performed is transmitted at step S1206, the partial-character-string acquisition processing is performed in one of the document managing apparatuses 200 that has received the command (step S1207). The details of the partial-character-string acquisition processing will be described later.

After the command requesting that a partial-character-string acquisition processing should be performed is transmitted, the partial-character-string receiving unit 121c included in the searching apparatus 100 waits until all the partial-character-strings are received (step S1208).

When all the partial-character-strings have been received, the second acquiring unit 124 connects the partial-character-strings together in ascending order according to the label values so as to generate result data (step S1209).

Next, the second result transmitting unit 121d transmits the generated result data to the client 400, which is the query requesting source (step S1210). Thus, the structured document search processing is ended.

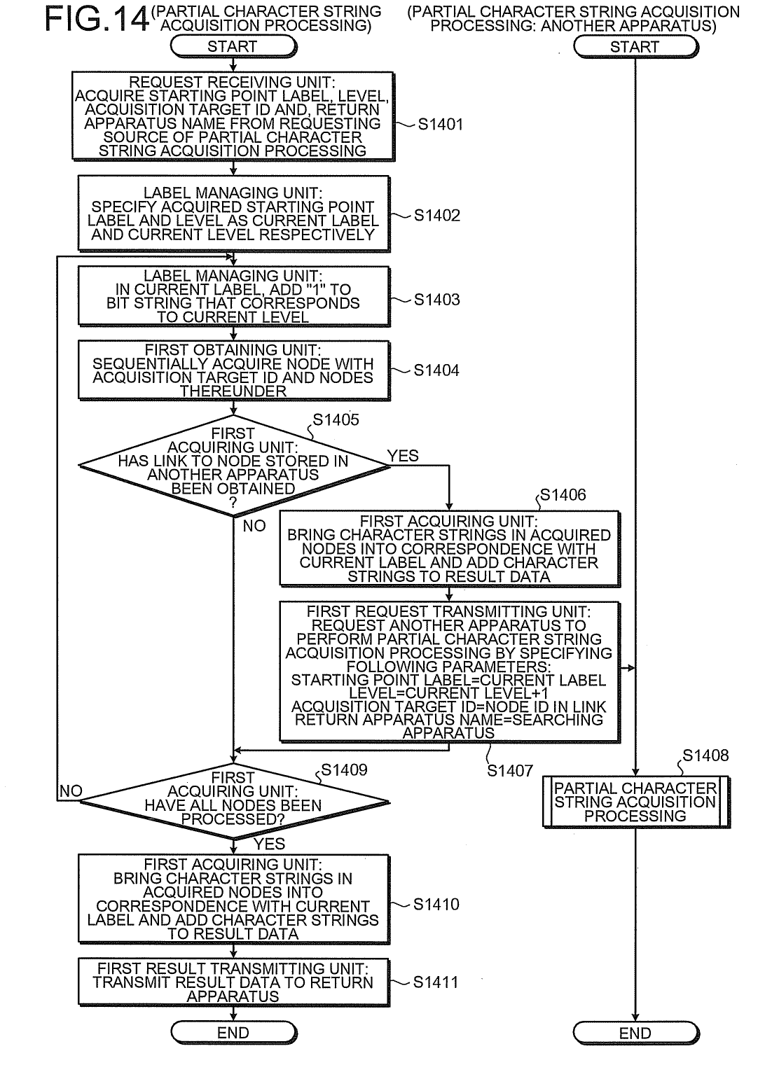

Next, the partial-character-string acquisition processing performed at step S1206 will be explained, with reference to FIG. 14.

First, the request receiving unit 121e acquires a starting point label, a level, a acquisition target ID, and a return apparatus name, from the requesting source of the partial-character-string acquisition processing (step S1401).

Next, the label managing unit 123 specifies the acquired starting point label as the current label and the acquired level as the current level (step S1402). The “current level” denotes the level of a fragment that corresponds to the partial-character-string on which a processing is currently performed.

Next, the label managing unit 123 adds “1” to a bit string for a portion of the current label that corresponds to the current level (step S1403).

Subsequently, the first acquiring unit 224 sequentially acquires the node with the acquisition target ID and the nodes thereunder (step S1404). For example, out of the structured document that is arranged in a distributed manner as shown in FIG. 7, when the node ID=d1-1 stored in the apparatus A is specified as an acquisition target ID, the nodes are sequentially acquired by following the parent-child relationships and the sibling relationships in the tree structure, e.g. the node ID=d1-1, the node ID=h1-1, and so on.

Next, the first acquiring unit 224 judges whether a link to a node stored in another apparatus has been acquired (step S1405). For example, when the link 60 as shown in FIG. 7 is acquired as a node following the node identified with the node ID=h1-1 in FIG. 7, the first acquiring unit 224 judges that a link to a node stored in another apparatus has been acquired.

When a link to a node stored in another apparatus has been acquired (step S1405: Yes), the first acquiring unit 224 brings the character strings in the nodes that have been acquired so far into correspondence with the current label and adds them to the result data (step S1406). In actuality, the first acquiring unit 224 brings the offset information within a character string buffer for the acquired character strings into correspondence with the current label and adds them to the result data.

Next, the first request transmitting unit 221b transmits, to the other apparatus that is specified in the link, a command requesting that a partial-character-string acquisition processing should be performed and in which parameters are specified (step S1407). In this situation, the starting point label=the current label, the level=the current level+1, the acquisition target ID=the node ID specified in the link, and the return apparatus name=the apparatus name of the searching apparatus 100 (i.e. the apparatus X) are specified.

The other apparatus that has received the request for a partial-character-string acquisition processing performs the partial-character-string acquisition processing recursively (step S1408).

When no link to a node stored in another apparatus has been acquired at step S1405 (step S1405: No), the first acquiring unit 224 judges whether all the nodes have been processed (step S1409). If not all the nodes have been processed (step S1409: No), “1” is added to the current level, and the processing is repeated (step S1403).

If all the nodes have been processed (step S1409: Yes), the first acquiring unit 224 brings the character strings in the nodes that have been acquired so far into correspondence with the current label and adds them to the result data (step S1410).

Next, the first result transmitting unit 221d transmits the result data to the return apparatus (step S1411). Thus, the partial-character-string acquisition processing is ended.

Next, a specific example of the structured document search processing performed by the structured document searching system 10 according to the present embodiment will be explained.

In the following description, an example will be used in which the structured document 1 and the structured document 2 that are shown in FIG. 5 and FIG. 6, respectively are stored in the apparatuses in a distributed manner, as shown in FIG. 7, and also the result data that is made up of the node identified with the node ID=d1-1 and the nodes thereunder is acquired, using the structure information shown in FIG. 4.

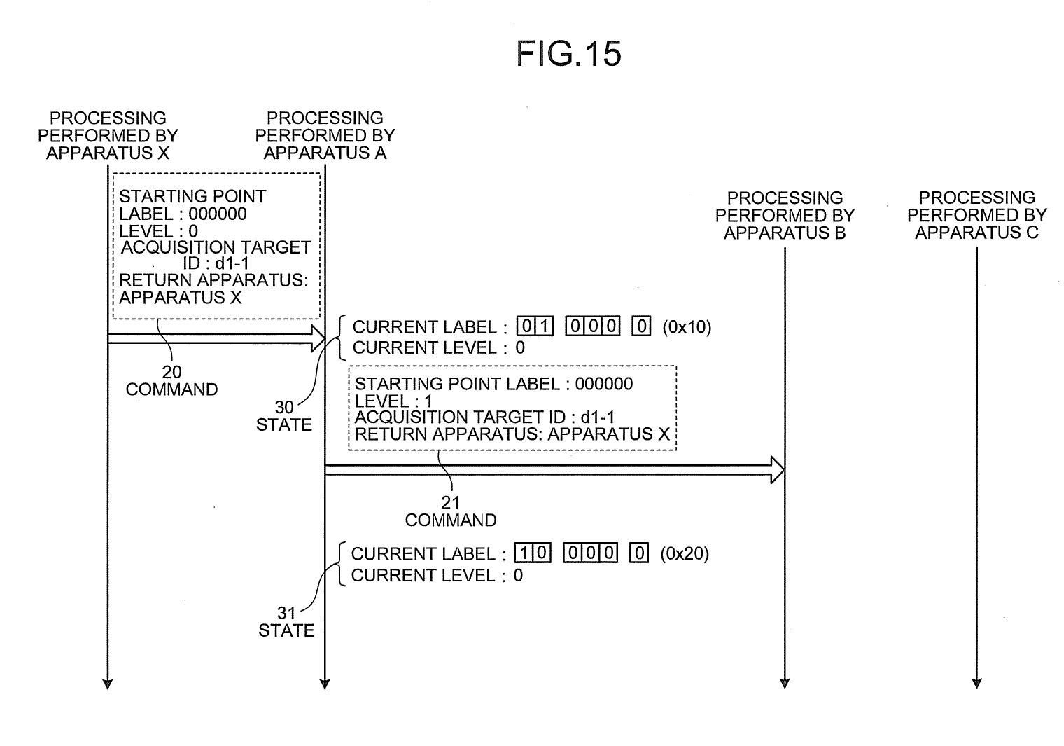

First, the label managing unit 123 included in the searching apparatus 100 generates a label of which the label size is 6 bits as shown in FIG. 13 and initializes the label with a “0” (step S1204). Because the node identified with the node ID=d1-1 is stored in the apparatus A, a command such as a command 20 shown in FIG. 15 is transmitted to the apparatus A (step S1206).

A partial-character-string acquisition processing is performed by the apparatus A (step S1207). Because the current level is “0”, “1” is added to the bit string for the portion that corresponds to the “level 0” (step S1403). As a result, the current label has a value as shown in the state 30.

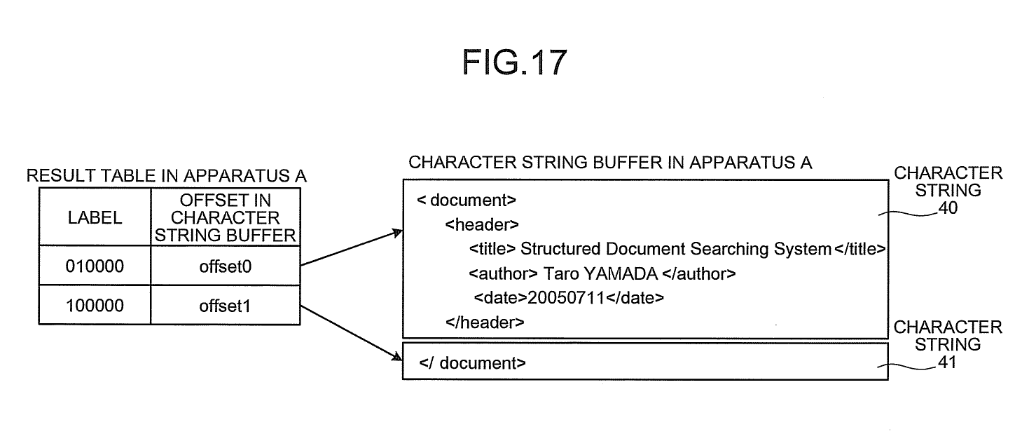

Subsequently, the node identified with the node ID=d1-1 and the nodes thereunder are sequentially read so that a character string 40 as shown in FIG. 17 is acquired (step S1404). Further, when another node is read, a link to the node ID=b1-1 that is stored in another apparatus, namely the apparatus B, is acquired (step S1405: Yes).

Thus, as shown in FIG. 17, an offset that indicates the character string 40 and the current label “0100000” are added to the result data (step S1406).

The result data is made up of a result table and a character string buffer. In the example shown in FIG. 17, the result data is made up of two character strings that have labels “0100000” and “1000000”, respectively. The labels and the character strings are brought into correspondence with each other by offsets within the character string buffer. The offset for the label “0100000” is “offset0”, whereas the offset for the label “1000000” is “offset1”.

Subsequently, a command 21 as shown in FIG. 15 is transmitted to the other apparatus specified in the link, namely the apparatus B (step S1407).

Because not all the nodes have been processed (step S1409: No), “1” is added to the bit string so that the current label is updated as shown in the state 31 (step S1403). Subsequently, the first acquiring unit 224 acquires a character string 41 (step S1404).

As a result, because all the nodes have been processed (step S1409: Yes), the current label in the state 31 and the character string 41 are added to the result data (step S1410), and the result data is transmitted to the return apparatus, namely the apparatus X (step S1411).

As described above, in the apparatus A, the two partial-character-strings as shown in FIG. 17 are acquired, in correspondence with the two current labels before and after the command 21 transmitted to the apparatus B.

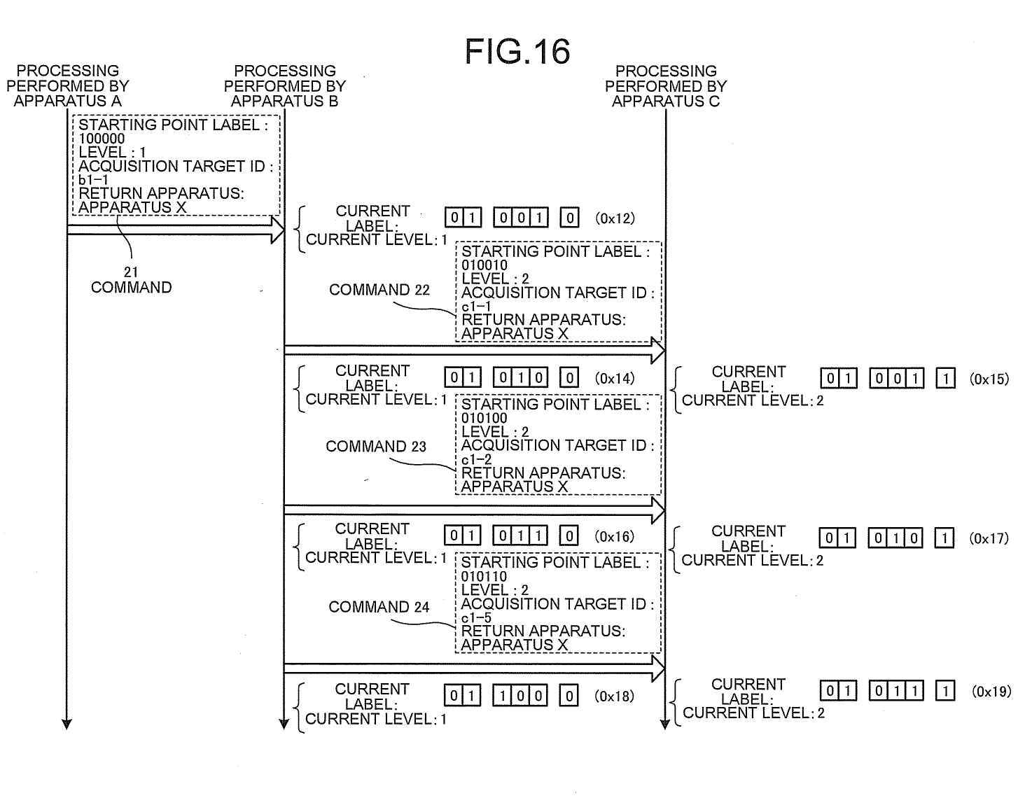

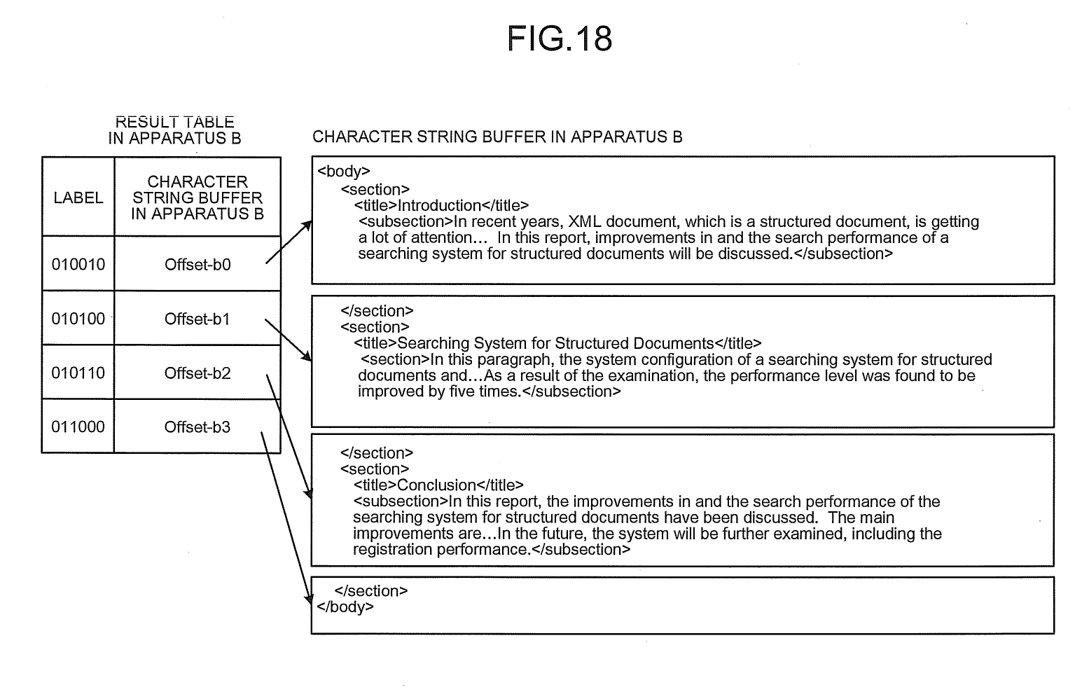

As a result of a similar processing, the apparatus B transmits a command 22, a command 23, and a command 24 as shown in FIG. 16 to the apparatus C. Consequently, four partial-character-strings as shown in FIG. 18 are acquired, in correspondence with the four current labels that are specified before and after the transmission of the commands.

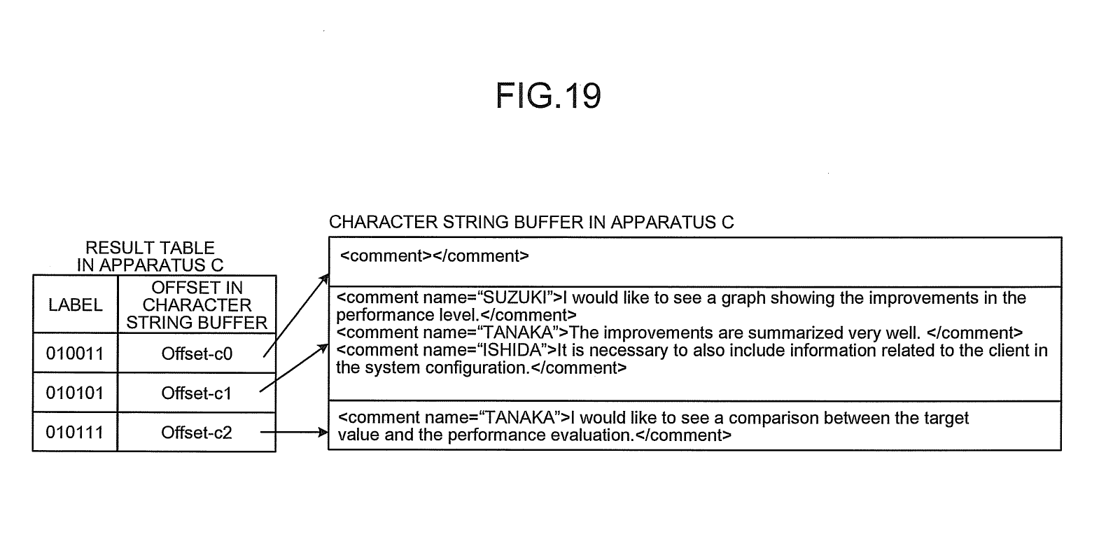

The apparatus C performs a partial-character-string acquisition processing three times in correspondence with the three commands transmitted from the apparatus B. As a result, three partial-character-strings as shown in FIG. 19 are acquired.

When the partial-character-strings shown in FIG. 17, FIG. 18, and FIG. 19 that have been acquired in this manner are arranged in ascending order according to the label values, the same character string as shown in FIG. 2, which serves as the acquired result, is generated.

The group of partial-character-strings acquired from each of the apparatuses is arranged in ascending order according to the label values. Thus, the cost required in arranging all the partial-character-strings in ascending order according to the label values is small. In addition, the size of the partial-character-string transferred to the apparatus X, which is the starting point of the result data acquisition, is the same as the size according to the conventional method. Thus, the processing load for the apparatus X will not be excessive.

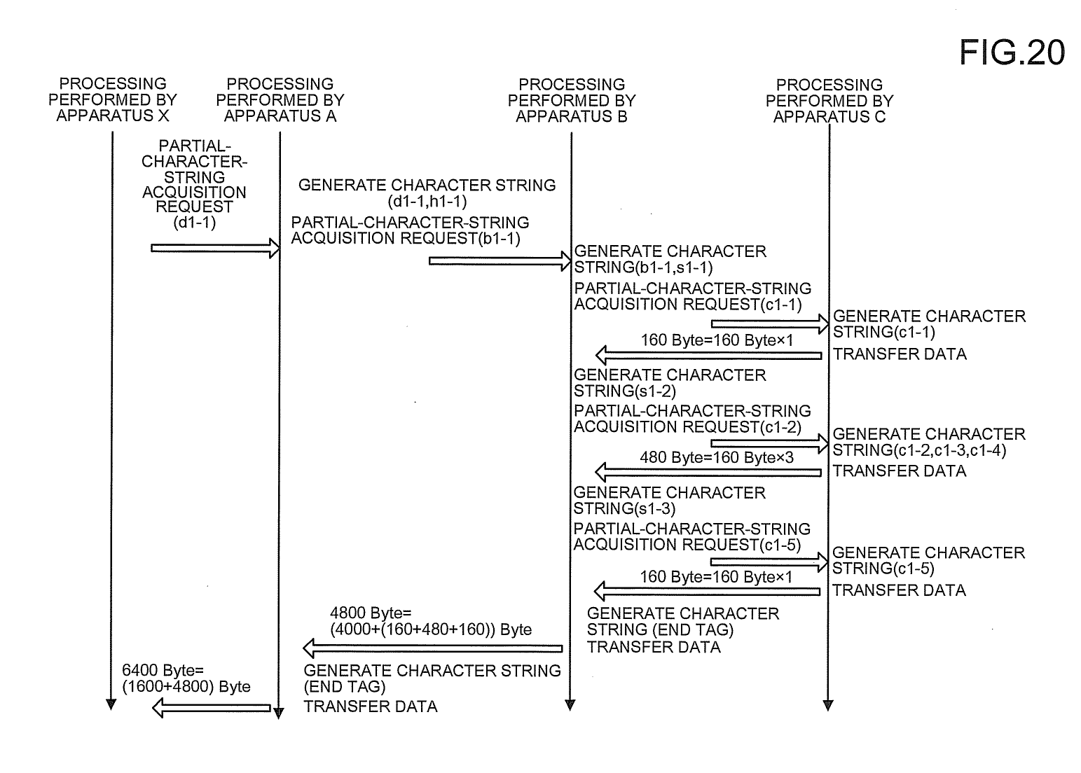

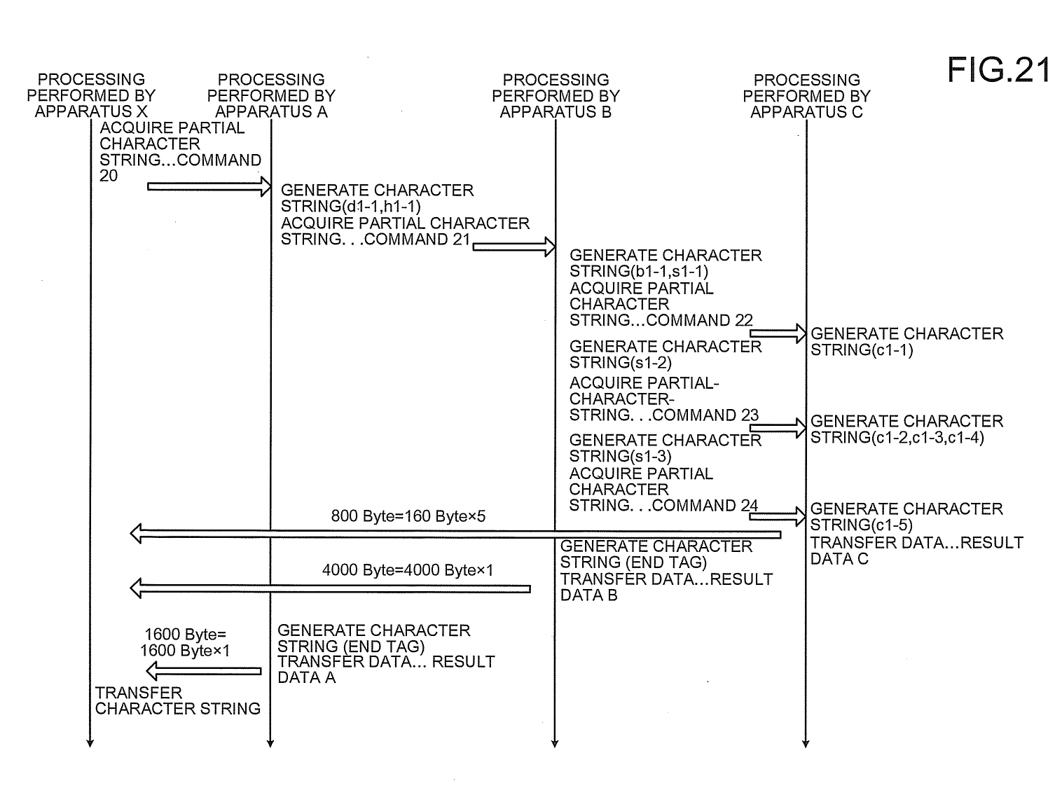

Next, advantages of the structured document searching system 10 according to the present embodiment will be explained, in comparison to the conventional technique, with reference to FIG. 20 and FIG. 21. In FIG. 21, an example of data transmitted when a search processing is performed using the same criteria as shown in FIG. 20 is shown.

In this example, it is assumed that the data size of the subtree with the “document” tag and thereunder from which the “body” tag and thereunder is eliminated is 1600 bytes, whereas the data size of the subtree with the “body” tag and thereunder from which the “comment” tag and thereunder is eliminated is 4000 bytes, and the data size of the “comment” tag portion is 160 bytes.

According to the conventional method, the partial-character-string acquired in each of the apparatuses is transferred to another apparatus positioned on an adjacent level. For example, a partial-character-string with a “comment” tag acquired in the apparatus C is transferred to the apparatus B. The apparatus B then connects the partial-character-string transferred from the apparatus C to a partial-character-string acquired in the apparatus B and transfers the connected character strings to the apparatus A. This way, the partial-character-string acquired in each apparatus is sequentially connected together so that a partial-character-string that serves as a search result is eventually transferred to the apparatus X.

Accordingly, as shown in FIG. 20, the data transfer volume from the apparatus C to the apparatus B is (160+480+160) bytes=800 bytes. The data transfer volume from the apparatus B to the apparatus A is 4800 bytes. The data transfer volume from the apparatus A to the apparatus X is 6400 bytes. The total data transfer volume is 12000 bytes.

On the other hand, when the method according to the present embodiment is used, the partial-character-string acquired in each apparatus is directly transferred to the apparatus X, which is the partial-character-string acquisition requesting source. Accordingly, the data transfer volume from the apparatus A to the apparatus X is 1600 bytes. The data transfer volume from the apparatus B to the apparatus X is 4000 bytes. The data transfer volume from the apparatus C to the apparatus X is 800 bytes. The total data transfer volume is 6400 bytes.

Thus, when the method according to the present embodiment is compared with the conventional method, the data transfer volume is reduced by 5600 bytes. The larger the data size of a fragment on a larger level is, the larger the effect of the data transfer volume reduction is.

In addition, it is not necessary to perform a copy processing on character strings, the copy processing being performed when the partial-character-strings are connected together in each apparatus. Consequently, the throughput of the entire search processing is improved.

Further, when it is possible to fix a specific apparatus as the return apparatus, it is acceptable to arrange so that the network communication line that is connected to the return apparatus and is used for return communication is a dedicated communication line having a single-direction communication. With this arrangement, it is possible to realize a data transfer that is faster than in a bidirectional communication.

As explained above, when the structured document searching system according to the present embodiment is used, it is possible to transfer the partial documents that serve as the search results and are arranged in the plurality of document managing apparatus in a distributed manner, from the document managing apparatuses directly to the searching apparatus that has made the search request. Thus, it is possible to reduce duplicate data transfers and to realize a high-speed search.

In addition, because the document managing apparatuses do not relay the search results, data copying is not performed any more than necessary. Thus, it is possible to perform the search even faster. Also, when it is possible to fix a specific apparatus as the apparatus that asks for result data, it is possible to realize a transfer that is at a higher speed than in a bidirectional data transfer, by applying a dedicated communication line and a single-direction data transfer. Consequently, it is possible to realize a high-speed search.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A structured document searching system comprising:
a plurality of document managing apparatuses that stores a structured document in a distributed manner;
a searching apparatus that is connected to the document managing apparatuses via a network and that is operable to search in the structured document from the document managing apparatuses; and
a client apparatus that is connected to the document managing apparatuses and the searching apparatus via a network and that is operable to transmit a search request for the structured document to the searching apparatus, wherein
each of the document managing apparatuses includes:
a document storing unit that stores a partial-character-string of the structured document corresponding to a predetermined one of structure elements that are used as units of a logical structure of the structured document;
a request receiving unit that receives an acquisition request for the partial-character-string from other ones of the document managing apparatuses and the searching apparatus;
a first acquiring unit that acquires the partial-character-string from the document storing unit based on the received acquisition request, and judges whether a portion of the acquired partial-character-string is stored in any one of the other document managing apparatuses, based on information that is contained in the acquired partial-character-string and indicates that a portion of the acquired partial-character-string is stored in one of the other document managing apparatuses;
a first request transmitting unit that transmits an acquisition request for the portion of the partial-character-string to the one of the other document managing apparatuses that is judged to store the portion of the partial-character-string, when it is judged that the portion of the partial-character-string is stored in the one of the other document managing apparatuses; and
a first result transmitting unit that transmits the acquired partial-character-string to the searching apparatus, and
the searching apparatus includes:
a structure information storing unit that stores structure IDs and apparatus IDs being kept in correspondence with each other, each of the structure IDs uniquely identifying one of the structure elements, and each of the apparatus IDs uniquely identifying one of the document managing apparatuses that stores the partial-character-string corresponding to the structure elements;
a search request receiving unit that receives the search request from the client apparatus;
a searching unit that acquires from the structure information storing unit one of the structure IDs of one of the structure elements that satisfies the received search request;
a second acquiring unit that acquires from the structure information storing unit one of the apparatus IDs of one of the document managing apparatuses that is in correspondence with the acquired structure ID;
a second request transmitting unit that transmits the acquisition request to the one of the document managing apparatuses that is identified with the acquired apparatus ID;
a partial-character-string receiving unit that receives the partial-character-string from one or more of the document managing apparatuses; and
a second result transmitting unit that connects the received partial-character-strings to one another and transmits a document acquired by connecting the partial-character-strings to the client apparatus, when the partial-character-string is received from each of the document managing apparatuses.

2. The system according to claim 1, wherein
the document storing unit stores the partial-character-string that is a predetermined one of subtrees within the structured document that is expressed using a tree structure,
the second request transmitting unit transmits hierarchy information and the acquisition request being kept in correspondence with each other to the one of the document managing apparatuses that is identified with the acquired apparatus ID, the hierarchy information including information indicating a depth of a hierarchical level of a root node of the partial-character-string with respect to a root node of the tree structure representing the entire structured document,
the first result transmitting unit transmits to the searching apparatus the acquired partial-character-string and the hierarchy information being kept in correspondence with each other, and
the second result transmitting unit connects the partial-character-string on a higher hierarchical level in front of the partial-character-string on a lower hierarchical level, based on the hierarchy information, and transmits the connected partial-character-strings to the client apparatus, when more than one partial-character-string is transmitted.

3. The system according to claim 2, wherein
the first result transmitting unit transmits, to the searching apparatus, the acquired partial-character-string and the hierarchy information that includes order information indicating an order of the acquisition of the partial-character-string, the acquired partial-character-string and the hierarchy information being kept in correspondence with each other, and
the second result transmitting unit connects the partial-character-string on the higher hierarchical level in front of the partial-character-string on the lower hierarchical level, based on the hierarchy information including the order information, when more than one partial-character-string is transmitted, the second result transmitting unit connects the partial-character-string acquired earlier in front of the partial-character-string acquired later, when the partial-character-strings are on a same level as each other, and the second result transmitting unit transmits the connected partial-character-strings to the client apparatus.

4. The system according to claim 3, wherein
the structure information storing unit stores the structure IDs each of which uniquely identifies the one of the structure elements, the apparatus IDs each of which uniquely identifies the one of the document managing apparatuses that stores the partial-character-string corresponding to one of the structure elements, and frequency information that indicates how many pieces the partial-character-string appear in the structured document, the structure IDs, the apparatus IDs, and the frequency information being kept in correspondence with each other, and
the second request transmitting unit determines a size of the hierarchy information, based on the frequency information stored in the structure information storing unit.

5. The system according to claim 2, wherein
the document storing unit stores connection information that includes the apparatus ID of the one of the other document managing apparatuses storing the portion of the partial-character-string and a node ID that uniquely identifies a root node of the portion of the partial-character-string, in correspondence with the partial-character-string that includes the portion of the partial-character-string, when a portion of the partial-character-string is stored in one of the other document managing apparatuses, and
the first request transmitting unit transmits the acquisition request for the partial-character-string whose root node is the node identified with the node ID contained in the connection information, to the one of the other document managing apparatuses that corresponds to the apparatus ID contained in the connection information, when the acquired partial-character-string is kept in correspondence with the connection information.

6. The system according to claim 2, wherein
the document storing unit stores connection information that includes the structure ID of the structure element corresponding to the portion of the partial-character-string and a node ID that uniquely identifies a root node of the portion of the partial-character-string, in correspondence with the partial-character-string that includes the portion of the partial-character-string, when a portion of the partial-character-string is stored in one of the other document managing apparatuses, and
the first request transmitting unit acquires the apparatus ID that is in correspondence with the structure ID contained in the connection information from the structure information storing unit, when the acquired partial-character-string is kept in correspondence with the connection information, and transmits, to the one of the document managing apparatuses that corresponds to the acquired apparatus ID, the acquisition request for the partial-character-string whose root node is the node identified with the node ID contained in the connection information.

7. The system according to claim 1, wherein
the second request transmitting unit transmits, to the one of the document managing apparatuses that is identified with the acquired apparatus ID, the acquisition request that contains transmission information used for transmitting information to the searching apparatus, and the first result transmitting unit transmits the acquired partial-character-string to the searching apparatus, based on the transmission information contained in the acquisition request.

8. The system according to claim 1, wherein
the first result transmitting unit transmits the acquired partial-character-string to the searching apparatus, using a communication line of the network that transmits information to the searching apparatus in a single direction.

9. The system according to claim 1, wherein
the document storing unit stores the partial-character-string that is a predetermined part of the structured document written in an Extensible Markup Language (XML).

10. The system according to claim 1, further comprising:
an index information storing unit that stores index information that corresponds elements each being a character string used as a search key and character string IDs each of which uniquely identifying the partial-character-string that contains the corresponding one of the elements, wherein
the searching unit that acquires from the index information storing unit one of the character string IDs that is in correspondence with one of the elements that satisfies the received search request, and acquires from the structure information storing unit one of the structure IDs of one of the structure elements that is in correspondence with the partial-character-string identified with the acquired character string ID.

11. A structured document searching method used in a structured document searching system that includes:
a plurality of document managing apparatuses that stores a structured document in a distributed manner;
a searching apparatus that is connected to the document managing apparatuses via a network and that is operable to search in the structured document from the document managing apparatuses; and
a client apparatus that is connected to the document managing apparatuses and the searching apparatus via a network and that is operable to transmit a search request for the structured document to the searching apparatus, the method comprising:
receiving the search request from the client apparatus;
acquiring one of the structure IDs of one of structure elements that satisfies the received search request, from a structure information storing unit that stores structure IDs each of which uniquely identifies one of the structure elements that are used as elements of a logical structure of the structured document, in correspondence with apparatus IDs each of which uniquely identifies one of the document managing apparatuses that stores the partial-character-string corresponding to one of the structure elements;
acquiring one of the apparatus IDs of one of the document managing apparatuses corresponding to the acquired structure ID, from the structure information storing unit;
transmitting an acquisition request to the one of the document managing apparatuses that is identified with the acquired apparatus ID;
receiving the acquisition request for the partial-character-string from other ones of the document managing apparatuses and the searching apparatus;
acquiring the partial-character-string from a document storing unit that stores the partial-character-string of the structured document corresponding to a predetermined one of the structure elements, based on the received acquisition request;
judging whether a portion of the acquired partial-character-string is stored in any one of the other document managing apparatuses, based on information that is contained in the acquired partial-character-string and indicates that a portion of the acquired partial-character-string is stored in the one of the other document managing apparatuses;
transmitting an acquisition request for the portion of the partial-character-string to the one of the other document managing apparatuses that is judged to store the portion of the partial-character-string, when it is judged that the portion of the partial-character-string is stored in the one of the other document managing apparatuses;
transmitting the acquired partial-character-string to the searching apparatus;
receiving the partial character sting from one or more of the document managing apparatuses; and
connecting a plurality of the partial-character-strings to one another and transmitting a document acquired by connecting the partial-character-strings to the client apparatus, when more than one character string is received.
